(19) United States
(12) Patent Application Publication
(10) Pub. No.: US 2008/0035425 A1
(43) Pub. Date: Feb. 14, 2008

(54) Mass Rescue and Evacuation System

(75) Inventors: Oren Meitus, Alfei-Menashe (IL); David Bichachi, Tsur-Moshe (IL); Daniel Ashkenazi, Tel Aviv (IL); Alexander Surdin, Rehovot (IL); Yaron Chen, Gan-Yavne (IL)

Correspondence Address: DARBY & DARBY P.C., P.O. BOX 770, Church Street Station, New York, NY, 10008-0770, US

(73) Assignee: ELECTRAL LTD., Rishon Lezion (IL)

(21) Appl. No.: 10/598,109

(22) PCT Filed: Feb. 13, 2005
(86) PCT No.: PCT/IL05/00182

§ 371 Date: Oct. 25, 2007

Related U.S. Application Data
(60) Provisional application No. 60/546,006, filed on Feb. 18, 2004.

(51) Int. Cl. A62B 1/02

(52) U.S. Cl. 182/129; 414/814

(57) ABSTRACT

A mass rescue system including at least one upper rotatable support, at least one lower rotatable support disposed below the at least one upper rotatable support, at least one elongate flexible element wound about the at least one upper and at least one lower rotatable supports and at least first and second rescue platforms mounted on the at least one elongate flexible element at locations therealong arranged with respect to the upper and lower rotatable supports such that downward motion of the first rescue platform produces concomitant upward motion of the second rescue platform and vice versa, the first and second rescue platforms, when loaded to different weights, being operative to undergo upward and downward motion produced by gravitational acceleration and without requiring an external energy source.

### REFERENCE TO RELATED APPLICATIONS

Reference is made to U.S. Provisional Patent Application No. 60/546,006, filed Feb. 18, 2004 entitled “MASS RESCUE AND EVACUATION SYSTEM FOR HIGH-RISE BUILDINGS BY TWO BALANCED CABINS AND A FAN DESCENDER” the disclosure of which is hereby incorporated by reference and priority of which is hereby claimed pursuant to 37 CFR 1.78(a) (4) and (5)(i).

### FIELD OF THE INVENTION

The present invention relates to mass rescue systems generally, and specifically to mechanical mass rescue systems.

### BACKGROUND OF THE INVENTION

The following U.S. published patent documents are believed to represent the current state of the art:

U.S. Pat. Nos. 6,830,126; 6,817,443; 6,808,047; 6,793,038; 6,598,703; 6,467,575; 6,318,503; 5,927,439; 5,562,184; 4,640,384; 4,616,735; 4,531,611; 4,433,752 and 4,424,884.

### SUMMARY OF THE INVENTION

The present invention seeks to provide a mass rescue and evacuation system designed for fast and easy evacuation of a large number of people from high structures.

There is thus provided in accordance with a preferred embodiment of the present invention a mass rescue system including at least one upper rotatable support, at least one lower rotatable support disposed below the at least one upper rotatable support, at least one elongate flexible element wound about the at least one upper and at least one lower rotatable supports and at least first and second rescue platforms mounted on the at least one elongate flexible element at locations therealong arranged with respect to the upper and lower rotatable supports such that downward motion of the first rescue platform produces concomitant upward motion of the second rescue platform and vice versa, the first and second rescue platforms, when loaded to different weights, being operative to undergo upward and downward motion produced by gravitational acceleration and without requiring an external energy source.

In accordance with a preferred embodiment of the present invention the mass rescue system also includes a dynamic resistance device operative to employ potential energy of the at least first and second rescue platforms for braking downward motion thereof. Preferably, the at least one elongate flexible element includes at least one first elongate flexible element which is wound over the upper rotatable support and at least one second elongate flexible element which is wound under the lower rotatable support. Alternatively, the at least one elongate flexible element includes a looped elongate element.

In accordance with another preferred embodiment of the present invention the mass rescue system also includes at least one guiding element which is operative to guide the first and second rescue platforms. Preferably, the at least one guiding element includes at least one rigid element. Alternatively, the at least one guiding element includes at least one elongate flexible element.

In accordance with yet another preferred embodiment of the present invention the mass rescue system also includes a counterweight operative to provide initial downward motion under gravitational acceleration and without requiring an external energy source. Preferably, at least one of the first and second rescue platforms includes a cabin. Additionally or alternatively, at least one of the first and second rescue platforms includes at least one guide assembly which rides along the at least one guiding element and which is operative to reduce transverse displacement of the rescue platform.

In accordance with a further preferred embodiment of the present invention at least one of the first and second rescue platforms also includes a safety assembly operative to prevent free-fall of the rescue platform. Preferably, the mass rescue system also includes at least one stair unit associated with the first and second rescue platforms. Alternatively or additionally, at least one of the first and second rescue platforms also includes at least one door and at least one door safety element operative to prevent vertical motion of the rescue platform while the at least one door is open.

In accordance with yet a further preferred embodiment of the present invention, at least one of the first and second rescue platforms also includes at least one of a first aid kit and a communications device. Preferably, the dynamic resistance device is operative to slow vertical motion of at least one of the first and second rescue platforms to a speed which is less than a predetermined speed. Alternatively or additionally, the dynamic resistance device also includes a reducing gearbox and a fan descender which are operative to slow the vertical motion of the first and second rescue platforms. Preferably, the dynamic resistance device also includes a position dependent gear controller operative to control the gear ratio of the reducing gearbox as a function of a vertical position of at least one of the first and second rescue platforms.

In accordance with still another preferred embodiment of the present invention the dynamic resistance device also includes a visually sensible position indicator associated with the position dependent gear controller. Preferably, the dynamic resistance device also includes a mechanical brake assembly operative, when in a first position, to prevent vertical motion of the first and second rescue platforms. More preferably, the mechanical brake assembly also includes a handle which is selectably movable between the first position and a second position to enable a user to selectably operate the system. Additionally or alternatively, the mass rescue system also includes at least one buffer for final stopping of vertical motion of the first and second rescue platforms.

There is also provided in accordance with a preferred embodiment of the present invention a method for mass rescue including providing upper and lower rotatable supports having at least one elongate flexible element wound thereabout, the at least one elongate flexible element having at least first and second rescue platforms mounted at locations therealong arranged with respect to the upper and lower rotatable supports such that downward motion of the first rescue platform produces concomitant upward motion of the second rescue platform and vice versa, providing dynamic resistance governing vertical motion of the at least one elongate flexible element with respect to the upper and lower rotatable supports and loading the first and second rescue platforms to different weights such that the first and second rescue platforms undergo upward and downward motion produced by gravitational acceleration and without requiring an external energy source.

In accordance with a preferred embodiment of the present invention the method also includes providing at least one guiding element which is operative to guide the first and second rescue platforms and mounting the at least one guiding element onto a building. Preferably, the method also includes operating a brake assembly to enable vertical motion of at least one of the first and second rescue platforms. More preferably, the method also includes operating the brake assembly to stop at least one of the first and second rescue platforms at a selectable level.

In accordance with another preferred embodiment of the present invention the method also includes prior to the providing a second rescue platform, providing at least one counter weight and loading the first platform to a lower weight than a weight of the counterweight such that downward gravitational motion of the counterweight results in upward motion of the first platform.

There is additionally provided in accordance with another preferred embodiment of the present invention a mass rescue system including an upper rotatable support, a lower rotatable support disposed below the upper rotatable support, at least one elongate flexible element wound about the upper and lower rotatable supports and a first rescue platform and a counterweight mounted on the at least one elongate flexible element at locations therealong arranged with respect to the upper and lower rotatable supports such that downward motion of the first rescue platform produces concomitant upward motion of the counterweight and vice versa, the first rescue platform having a weight, when loaded to at least a first predetermined extent, which is greater than a weight of the counterweight and thus being operative to undergo downward motion produced by gravitational acceleration, causing concomitant upward motion of the counterweight, and the first rescue platform having a weight, when unloaded to at least a second predetermined extent, which is less than the weight of the counterweight and thus the counterweight is operative to undergo downward motion produced by gravitational acceleration, causing concomitant upward motion of the first rescue platform, when unloaded to at least a second predetermined extent.

In accordance with a preferred embodiment of the present invention the counterweight includes at least a second rescue platform having a weight, when unloaded to at least a second predetermined extent, which is less than the weight of the first rescue platform, when loaded to at least a third predetermined extent and thus the counterweight is operative to undergo downward motion produced by gravitational acceleration, causing concomitant upward motion of the first rescue platform, when unloaded to at least a second predetermined extent.

In accordance with another preferred embodiment of the present invention the mass rescue system also includes a dynamic resistance device operative to employ potential energy of the first rescue platform for braking downward motion thereof. Preferably, the at least one elongate flexible element includes at least one first elongate flexible element which is wound over the upper rotatable support and at least one second elongate flexible element which is wound under the lower rotatable support. Alternatively, the at least one elongate flexible element includes a looped elongate element.

In accordance with yet another preferred embodiment of the present invention the mass rescue system also includes at least one guiding element, which is operative to guide the first rescue platform and the counterweight. Preferably, the at least one guiding element includes at least one rigid element. Alternatively, the at least one guiding element includes at least one elongate flexible element. More preferably, the first rescue platform includes a cabin.

In accordance with still another preferred embodiment of the present invention the first rescue platform includes at least one guide assembly which rides along the at least one guiding element and which is operative to reduce transverse displacement of the first rescue platform. Additionally or alternatively, the first rescue platform also includes a safety assembly operative to prevent free-fall of the first rescue platform. Preferably, the mass rescue system also includes at least one stair unit associated with the first rescue platform.

In accordance with a further preferred embodiment of the present invention the first rescue platform also includes at least one door and at least one door safety element operative to prevent vertical motion of the first rescue platform while the at least one door is open. Preferably, the first rescue platform also includes at least one of a first aid kit and a communications device. Additionally or alternatively, the dynamic resistance device is operative to slow vertical motion of the first rescue platform to a speed which is less than a predetermined speed.

In accordance with yet a further preferred embodiment of the present invention the dynamic resistance device also includes a reducing gearbox and a fan descender which are operative to slow the vertical motion of the first rescue platform. Preferably, the dynamic resistance device also includes a position dependent gear controller operative to control the gear ratio of the reducing gearbox as a function of a vertical position of the first rescue platform. Additionally or alternatively, the dynamic resistance device also includes a visually sensible position indicator associated with the position dependent gear controller.

In accordance with a still further preferred embodiment of the present invention the dynamic resistance device also includes a mechanical brake assembly operative, when in a first position, to prevent vertical motion of the first rescue platform. Preferably, the mechanical brake assembly also includes a handle which is selectably movable between the first position and a second position to enable a user to selectably operate the system. Additionally or alternatively, the mass rescue system also includes at least one buffer for final stopping of vertical motion of the first rescue platform.

There is yet further provided in accordance with a further preferred embodiment of the present invention a method for mass rescue including providing upper and lower rotatable supports having at least one elongate flexible element wound thereabout, the at least one elongate flexible element having a first rescue platform and a counterweight mounted at locations therealong arranged with respect to the upper and lower rotatable supports such that downward motion of the first rescue platform produces concomitant upward motion of the counterweight and vice versa, providing dynamic resistance governing vertical motion of the at least one elongate flexible element with respect to the upper and lower rotatable supports and loading the first rescue platform to a first predetermined extent, such that it has a first weight which is greater than a weight of the counterweight, such that the first rescue platform undergoes downward motion produced by gravitational acceleration, causing concomitant upward motion of the counterweight and unloading the first rescue platform to at least a second predetermined extent, such that it has a second weight which is less than the weight of the counterweight and thus the counterweight is operative to undergo downward motion produced by gravitational acceleration, causing concomitant upward motion of the first rescue platform.

In accordance with a preferred embodiment of the present invention the counterweight includes at least a second rescue platform having a weight, when unloaded to at least a second predetermined extent, which is less than the weight of the first rescue platform, when loaded to at least a third predetermined extent and thus the counterweight is operative to undergo downward motion produced by gravitational acceleration, causing concomitant upward motion of the first rescue platform, when unloaded to at least a second predetermined extent. Preferably, the method also includes providing at least one guiding element which is operative to guide the first rescue platform and mounting the at least one guiding element onto a building.

In accordance with another preferred embodiment of the present invention the method also includes operating a brake assembly to enable vertical motion of the first rescue platform. Preferably, the method also includes operating the brake assembly to stop the first rescue platform at a selectable level.

### BRIEF DESCRIPTION OF THE DRAWINGS

The present invention will be understood and appreciated more fully from the following detailed description, taken in conjunction with the drawings in which:

FIG. 1 is a simplified pictorial illustration of a mass rescue and evacuation system constructed and operative in accordance with a preferred embodiment of the present invention;

FIGS. 2A and 2B are simplified pictorial illustrations of top and bottom portions of the mass rescue and evacuation system of FIG. 1;

FIGS. 3A and 3B are simplified pictorial illustrations of two embodiments of the mass rescue and evacuation system of FIG. 1, shown with and without stairs associated therewith;

FIG. 4 is a simplified bottom view pictorial illustration of the mass rescue and evacuation system of FIG. 3A having a passenger cabin attached thereto;

FIGS. 5A and 5B are simplified pictorial illustrations of the passenger cabin which forms part of the mass rescue and evacuation system of FIGS. 1-4;

FIG. 6 is a simplified bottom view pictorial illustration of the mass rescue and evacuation system of FIG. 4 having a fan-descender attached thereto;

FIGS. 7A, 7B, 7C, 7D, 7E, 7F and 7G are simplified pictorial illustrations of typical use of the mass rescue and evacuation system of FIGS. 1-6;

FIG. 8 is a simplified illustration of an alternative embodiment of the mass rescue and evacuation system of the present invention;

FIGS. 9A and 9B illustrate two features of an alternative embodiment of the mass rescue and evacuation system of the present invention;

FIG. 10 is a simplified top view illustrations of a further alternative embodiment of the present invention;

FIGS. 11A and 11B are two alternate simplified bottom portion front view illustrations of the embodiment of FIG. 10; and

FIG. 12 is a simplified pictorial illustration of yet another alternative embodiment of the present invention.

### DETAILED DESCRIPTION OF PREFERRED EMBODIMENTS

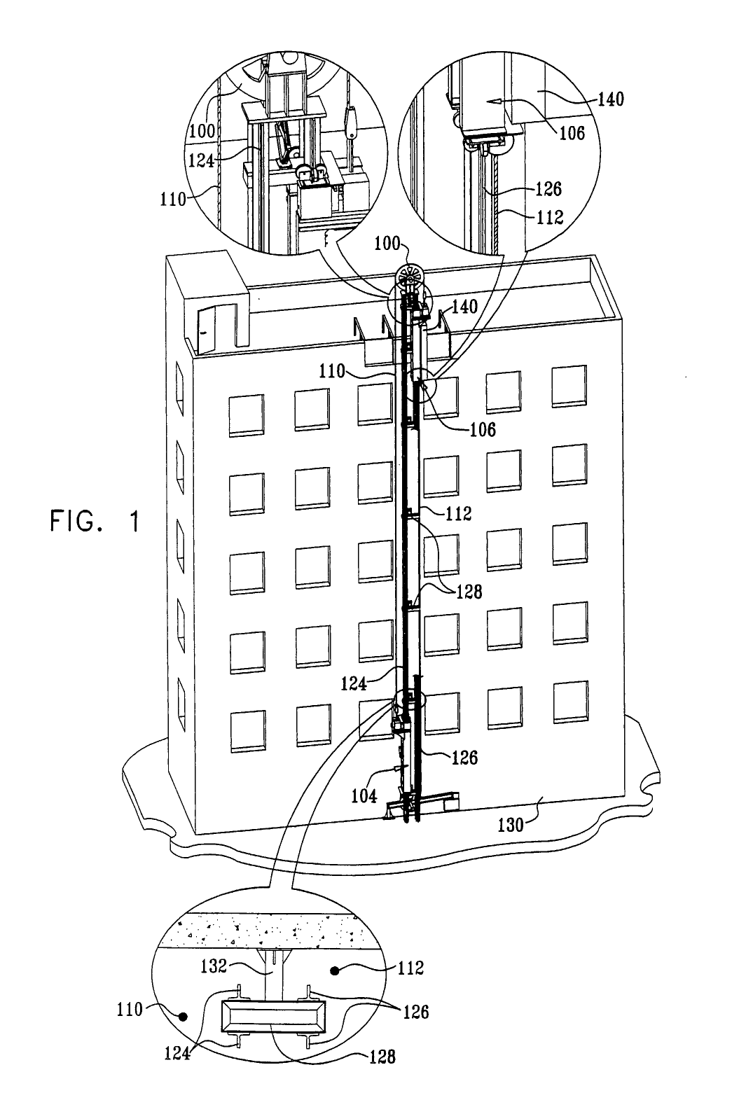

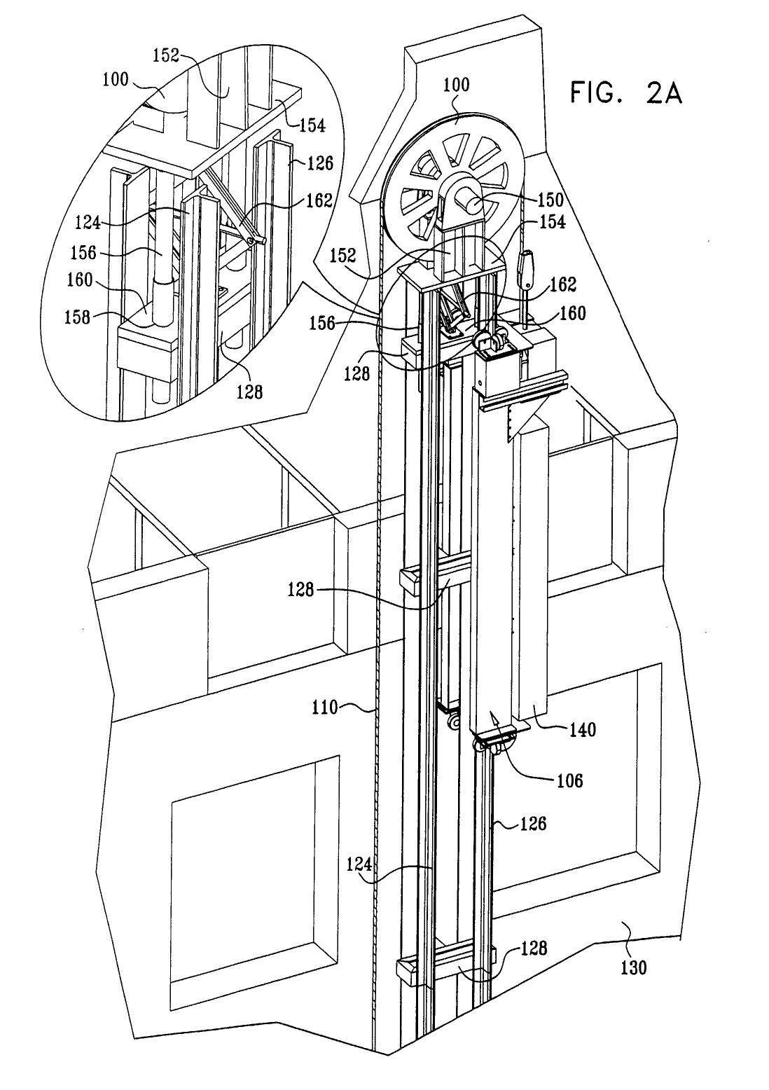

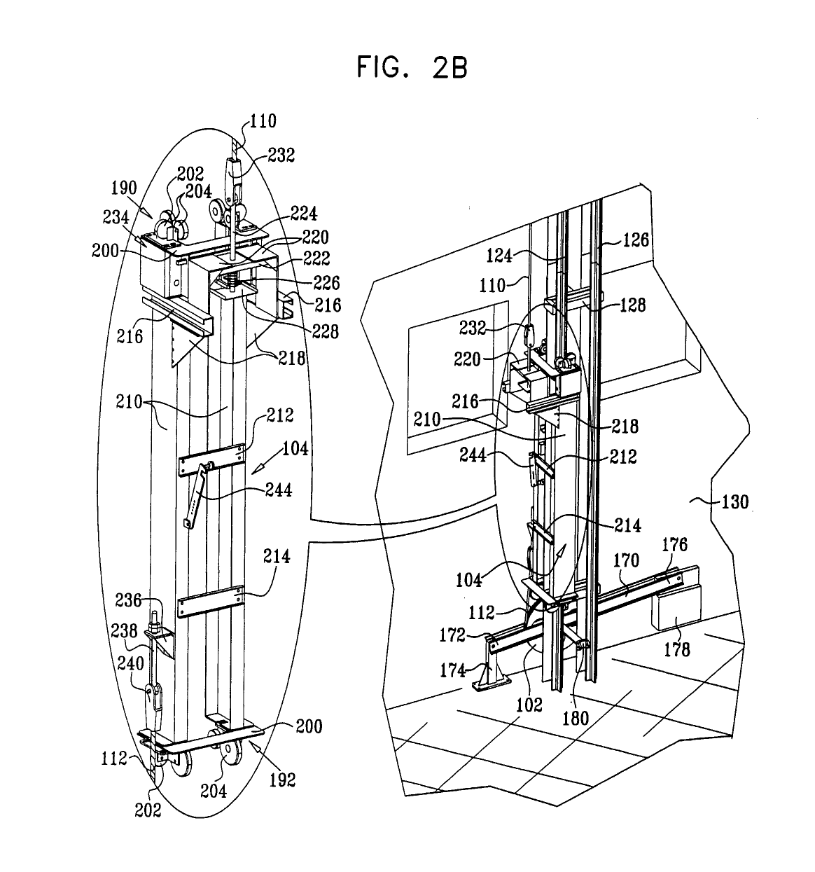

Reference is now made to FIG. 1, which is a simplified pictorial illustration of a mass rescue and evacuation system constructed and operative in accordance with a preferred embodiment of the present invention and to FIGS. 2A and 2B, which are simplified pictorial illustrations of top and bottom portions of the mass rescue and evacuation system of FIG. 1.

As seen in FIGS. 1-2B, the mass rescue and evacuation system is a passive, gravity-operated system and preferably includes top and bottom sheaves 100 and 102. Preferably top sheave 100 is a deflection sheave, while bottom sheave is a traction and tension sheave. A pair of cabin mount assemblies, designated by reference numerals 104 and 106 are arranged for gravity-driven, generally vertical motion between sheaves 100 and 102 and are mounted on first and second cables 110 and 112, which are wound over sheaves 100 and 102. Cable 110, known as a suspension cable, extends from the top of cabin mount assembly 104, over deflection sheave 100 to the top of cabin mount assembly 106 and thus supports both cabin mount assemblies 104 and 106. Cable 112, known as a compensation cable, extends from the bottom of cabin mount assembly 104 under traction sheave 102 to the bottom of cabin mount assembly 106.

The cabin mount assemblies 104 and 106 each ride along a pair of generally vertical guiding rails, respectively designated by reference numerals 124 and 126, which are mounted on vertically spaced brackets 128, which are, in turn, fixed to a wall 130 of a building in spaced relationship therewith, by respective wall mounts 132. As seen in FIGS. 1-2B, when the mass rescue and evacuation system is not in use, cabins are not attached to cabin mount assemblies 104 and 106, but a counterweight 140 is mounted on one of the cabin mount assemblies, here cabin mount assembly 106, which is located at the top of the building, in order to provide initial, gravity-driven vertical motion of the system. It is appreciated that evacuation need not necessarily take place from the top of the building but rather may take place from any desired level or levels.

Deflection sheave 100 is rotatably mounted on a generally horizontal axle 150 which is fixed onto an axle mount 152. Axle mount 152, is in turn mounted on a support element 154, which in turn is mounted on a pair of guide rods 156, which slidably extend through guide sockets 158, which are fixedly mounted onto the uppermost rail mounting bracket 128, here designated by reference numeral 160. Support element 154 is in turn supported onto a manually vertically adjustable lifting jack 162, which is mounted onto bracket 160 and provides selectably adjustable vertical positioning of deflection sheave 100. Vertical adjustment of the mounting height of axle 150 takes place from time to time in order to compensate for natural cable elongation which takes place over time.

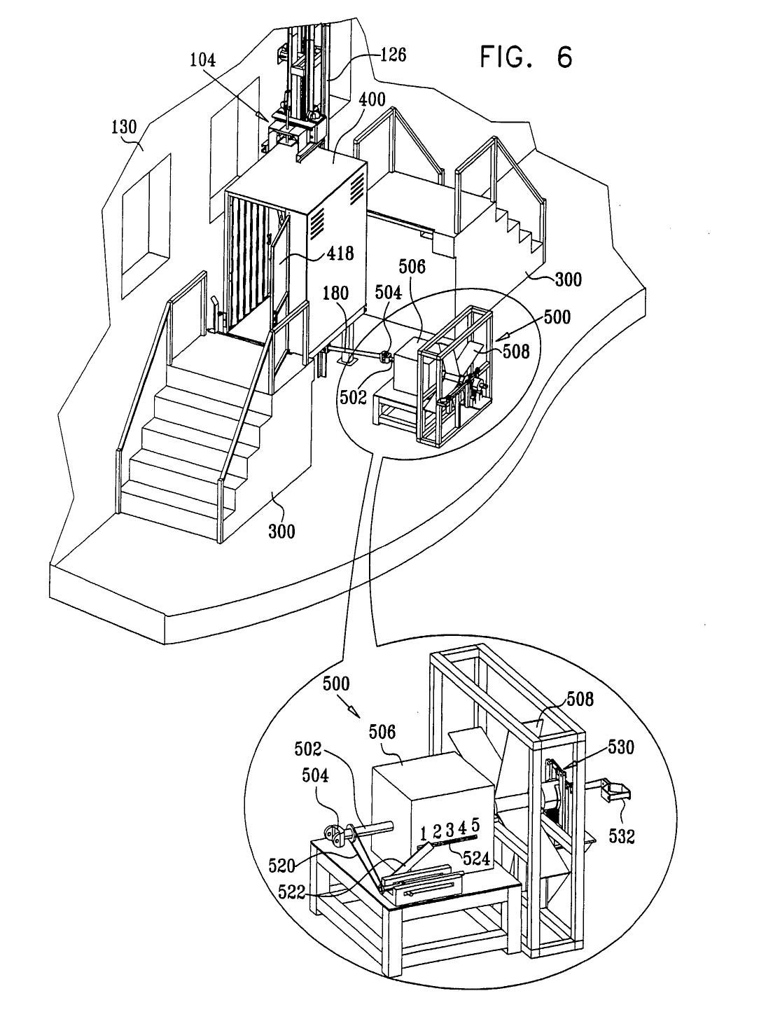

Traction sheave 102 is mounted onto a lever arm 170, which is pivotably mounted at one end thereof, designated by reference numeral 172 onto an anchored post 174. An opposite end 176 of lever arm 170 is weighted by a static weight 178, thus tensioning cables 110 and 112, to an extent required for suitable traction between cable 112 and traction sheave 102. A crankshaft 180 extends perpendicularly from a center of traction sheave 102 and is arranged for connection to a fan descender (not shown) as described hereinbelow with reference to FIG. 6.

Turning particularly to the enlarged portion of FIG. 2B, it is seen that the cabin mount assembly 104, which is identical to cabin mount assembly 106 includes top and bottom roller guide assemblies, designated respectively by reference numerals 190 and 192. The roller guide assemblies 190 and 192 enable the cabins (not shown) mounted onto cabin mount assemblies 104 and 106 to move vertically along guiding rails 124 and 126 at relatively high speed and with relatively low transverse displacement. Each roller guide assembly preferably includes a frame 200 onto which two sets 202, each including three wheels 204, are rotatably mounted.

Each cabin mount assembly includes a pair of parallel spaced beams 210, which are joined, inter alia by transverse elements 212 and 214 intermediate ends of the beams and by frame 200 at the bottoms of the beams 210. At the top of each of beams 210 there is provided a transverse element 216, which is additionally supported by a support 218. Mounted onto each transverse element 216 is a cable connection side support element 220. Fixedly attached to cable connection side support elements 220 is a suspension plate 222, which is apertured to permit slidable passage therethrough of an anchor rod 224. Below suspension plate 222, a spring 226 is mounted about anchor rod 224 and is seated on a retaining disk 228, which is fixed to a lower end of anchor rod 224 by nuts 230. At an upper end of anchor rod 224 there is provided a wedge cable socket 232 which connects anchor rod 224 to cable 110.

Supported on transverse elements 216 is an anti-free fall safety assembly 234. Assembly 234 preferably is identical or similar to a Model EB 75GS commercially available from Aufzugtechnologie G. Schlosser GmbH of Dachau, Germany.

At a lower side of one of beams 210, a bracket 236 mounted an anchor rod 238, at an end of which there is provided a wedge cable socket 240 which connects anchor rod 238 to cable 112.

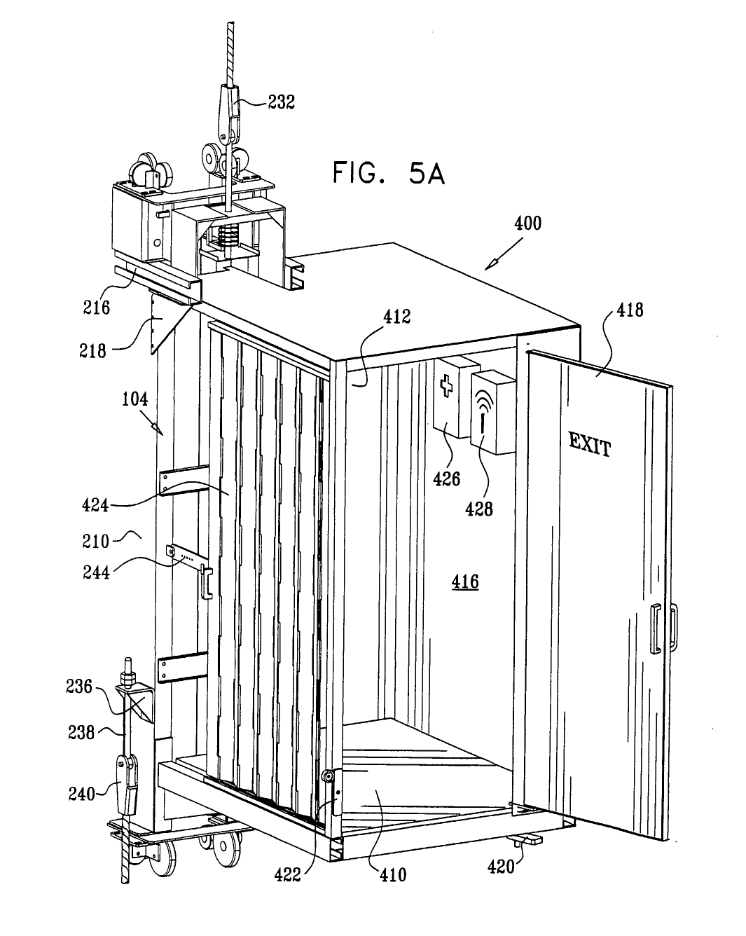

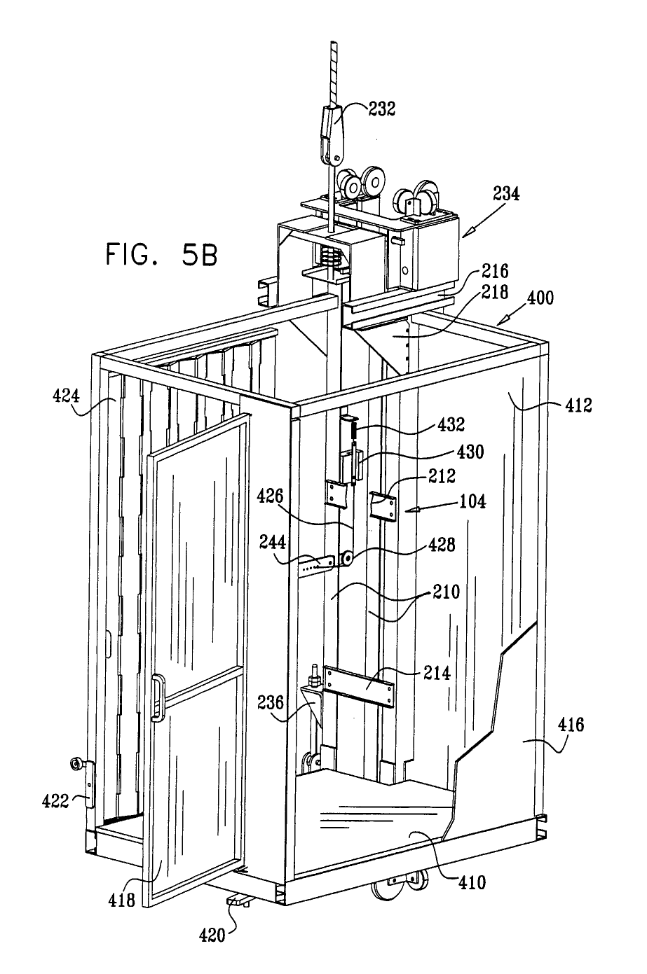

An entrance door safety latch 244, which cooperates with an entrance door safety mechanism, described hereinbelow with reference to FIGS. 5A and 5B, is preferably also mounted on one of beams 210.

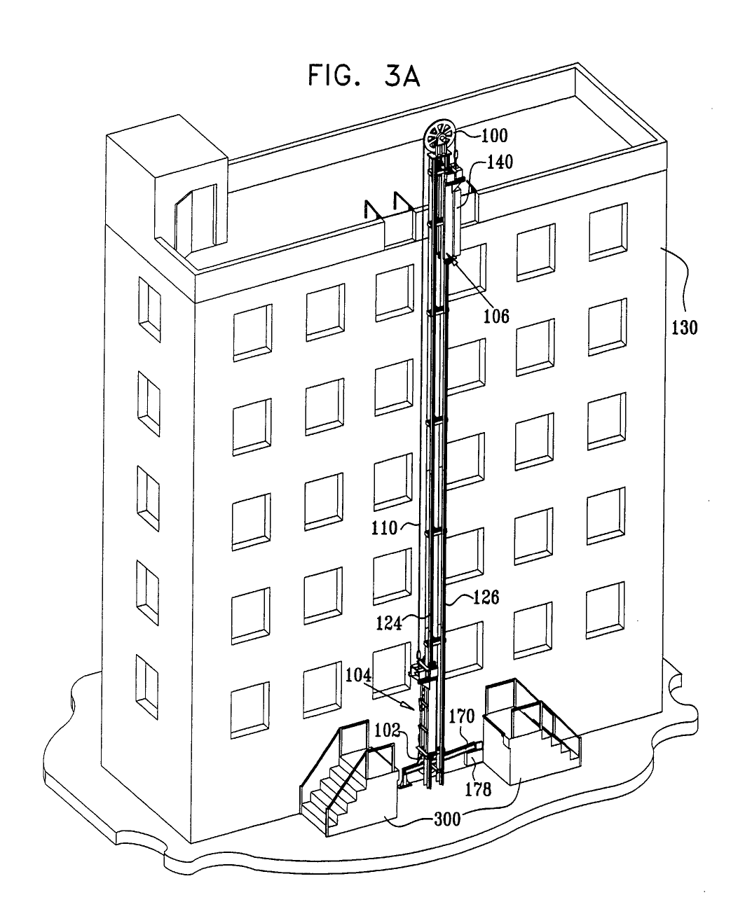

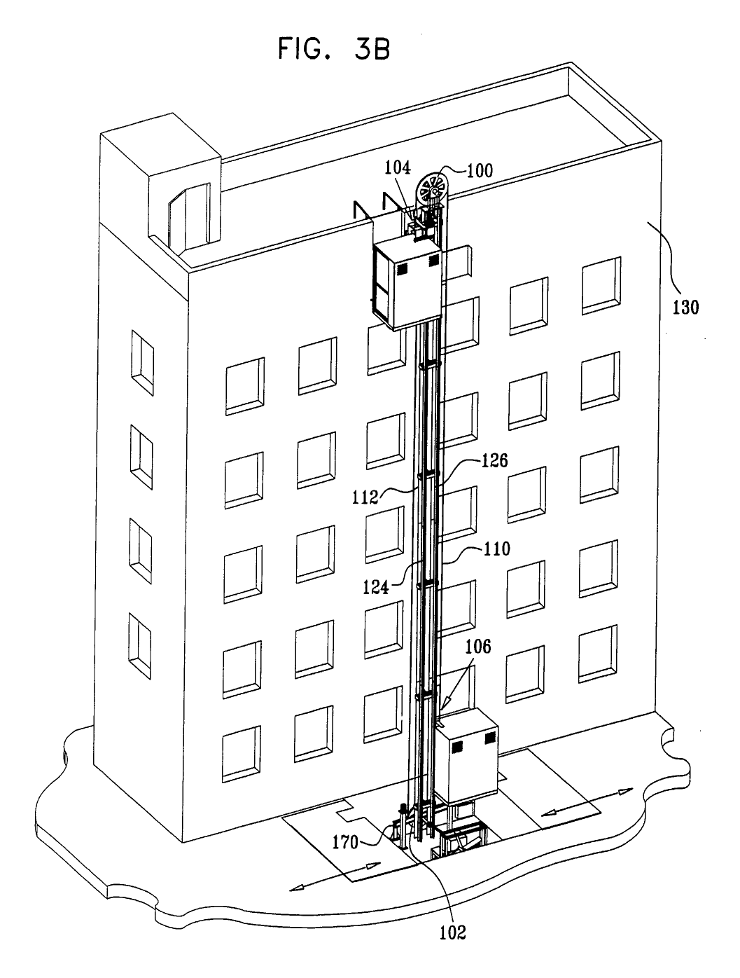

The system as described hereinabove with reference to FIGS. 1-2B is in its non-deployed, ready operative orientation. Stair units 300, as shown in FIG. 3A may be provided when the system is in its non-deployed operative orientation or may be moved into place when an emergency situation occurs. Alternatively stair units 300 may be obviated, as in the embodiment shown in FIG. 3B.

Normally, the cabins are not mounted onto the remainder of the system when the system is in its non-deployed operative orientation. Alternatively, one or both cabins may be mounted.

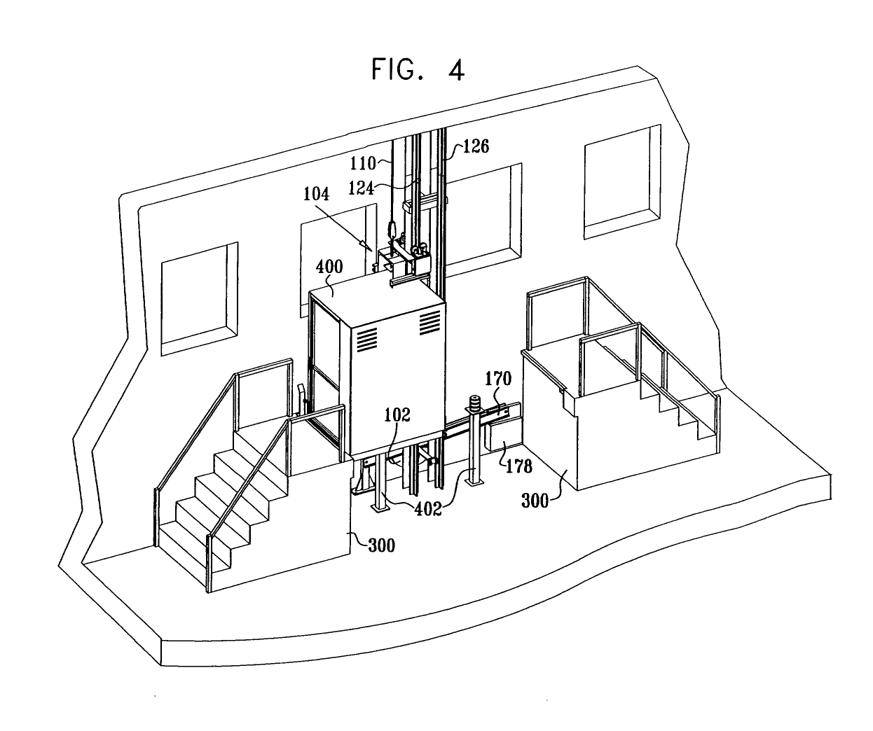

FIG. 4 illustrates a cabin 400 mounted onto cabin mount assembly 104. A pair of buffers 402, such as Model ACLA 300403 commercially available from ACLA-WERKE GmbH of Cologne, Germany are also illustrated, one of which underlies and is engaged by cabin 400.

Reference is now made to FIGS. 5A and 5B, which are simplified pictorial illustrations of cabin 400, mounted onto cabin mount assembly 104. As seen in FIGS. 5A and 5B, the cabin 400 preferably comprises a floor 410 and enclosure walls 412 and 416 preferably arranged at right angles to each other. Opposite wall 412, an exit door 418 is provided and is preferably configured as a swing door, swinging outwardly, as shown. An exit door safety device 420 is associated with exit door 418 and is operative to prevent upward vertical movement of the cabin when the exit door 418 is open. An additional exit door safety device 422 is associated with exit door 418 and prevents opening of exit door 418 except when the cabin is at a predetermined vertical position, suitable for egress of persons therefrom. Opposite wall 416 there is provided an entrance door 424, preferably configured as a slidable folding door. Entrance door 424 is operative to be engaged by entrance door safety latch 244.

Entrance door safety latch 244 is coupled by a cable 426, cooperating with rollers 428, to a safety device 430, such as a Model P.F.B. BP.2 commercially available from P.F.B. of Modena, Italy, which cooperates with a tension spring 432. Safety device 430 selectably engages guide rail 124, thus selectably locking the cabin 400 against downward vertical motion.

In the operative orientation shown in FIG. 5B, when the entrance door 424 is closed, latch 244 is in a generally horizontal orientation, locking the entrance door closed. In this generally horizontal orientation, latch 244, via cable 426 releases safety device 430, thereby permitting downward vertical displacement of the cabin 400.

When latch 244 is not in the generally horizontal orientation, it causes safety device 430 to engage the guide rail 124, thus preventing downward motion of the cabin and permits opening of the entrance door 424.

It is appreciated that cabin 400 may be equipped with a first aid kit 426 and a communications unit 428.

Reference is now made to FIG. 6, which illustrates a fan descender assembly 500. Fan descender assembly 500 preferably includes a shaft 502 to which is connected a crankshaft coupler 504 for connection to crankshaft 180. Shaft 502 is coupled to a reducing gearbox 506, typically having selectable gear ratios of 1:8 and 1:28. An output shaft of gearbox 506 is coupled to a fan 508, preferably providing sufficient dynamic resistance to limit the speed of descent of a loaded cabin 400 under gravitational acceleration to 3.5 meters per second.

Rotation of the shaft 502 is also coupled, preferably by a chain 520, to an automatic vertical position dependent gear ratio controller 522, which is operative, on the basis of the sensed rotation of the shaft 502 to determine the vertical position of the cabin 400 and to set the gear ratio accordingly. Thus, typically, when the loaded cabin 400 is lowered to a height of 10 meters above its intended landing position, the increased gear ratio is applied, thus reducing the speed of descent to a leveling speed of 1 meter per second. Preferably, associated with the gear ratio controller 522 is a mechanical visually sensible vertical position indicator 524. The descending cabin 400 comes to a complete stop by engagement with buffer 402. The height of the buffer 402 determines the exact level at which the cabins are stopped.

The output shaft of gearbox 506 is also preferably coupled to a mechanical brake assembly 530, which is normally locked, preventing vertical motion of the system. An authorized operator may operate a handle 532 of assembly 530, typically moving it downward, to unlock the brake assembly 530 and thus enable operation of the system. The visually sensible vertical position indicator 524 may be employed by the authorized operator to move the brake handle 532 upward thereby to stop the cabin 400 at an intermediate level of the building, if desired.

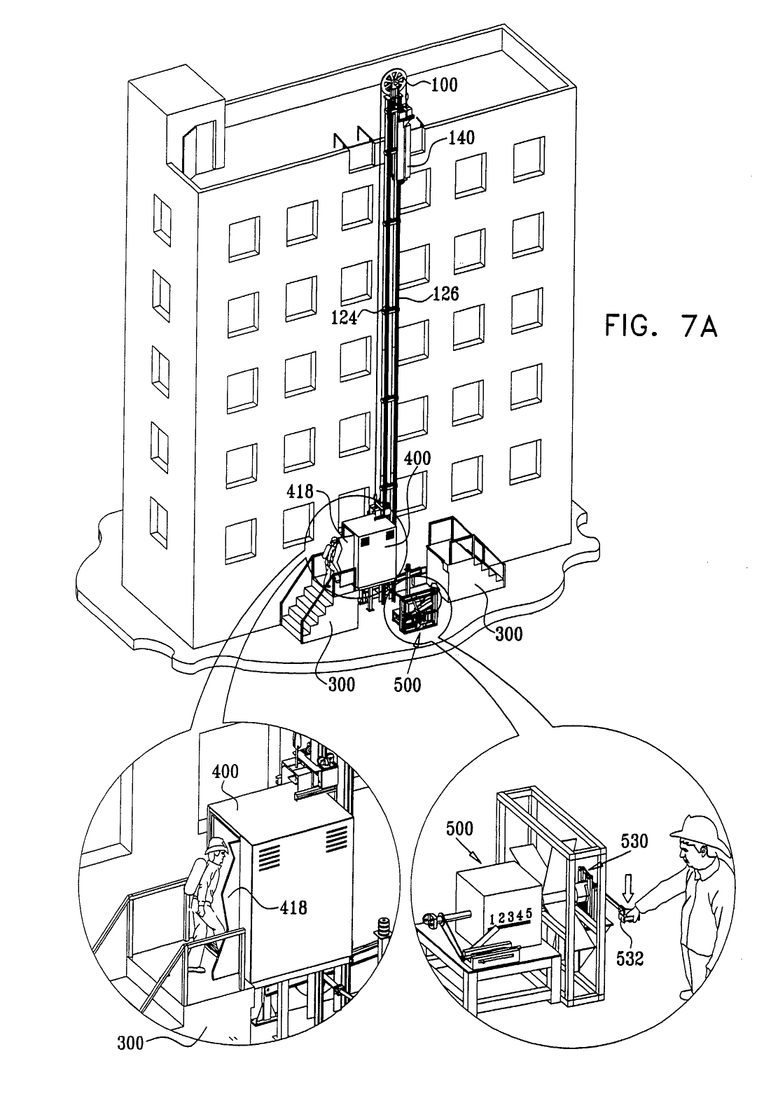

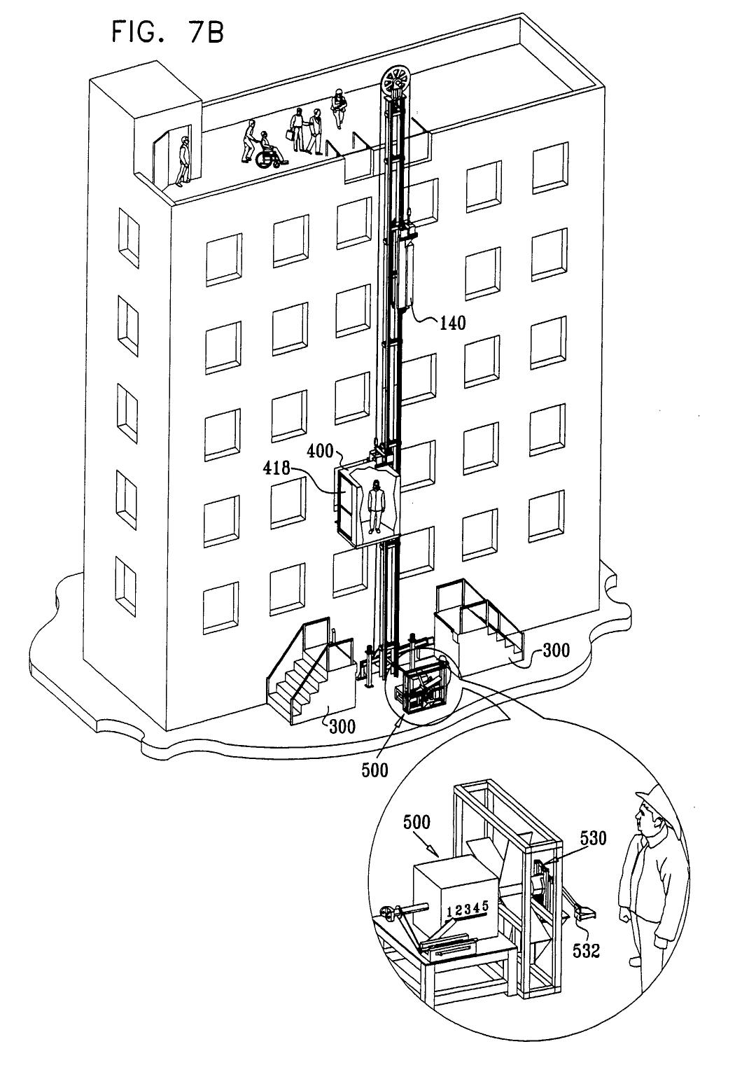

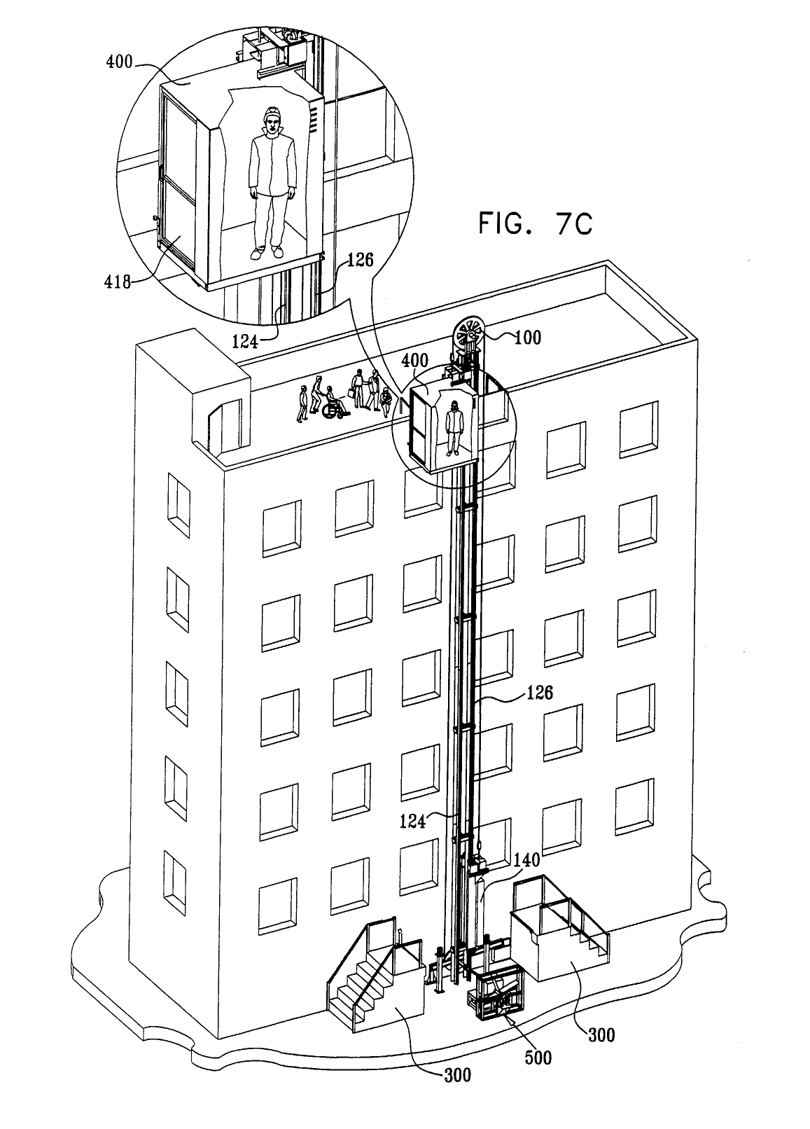

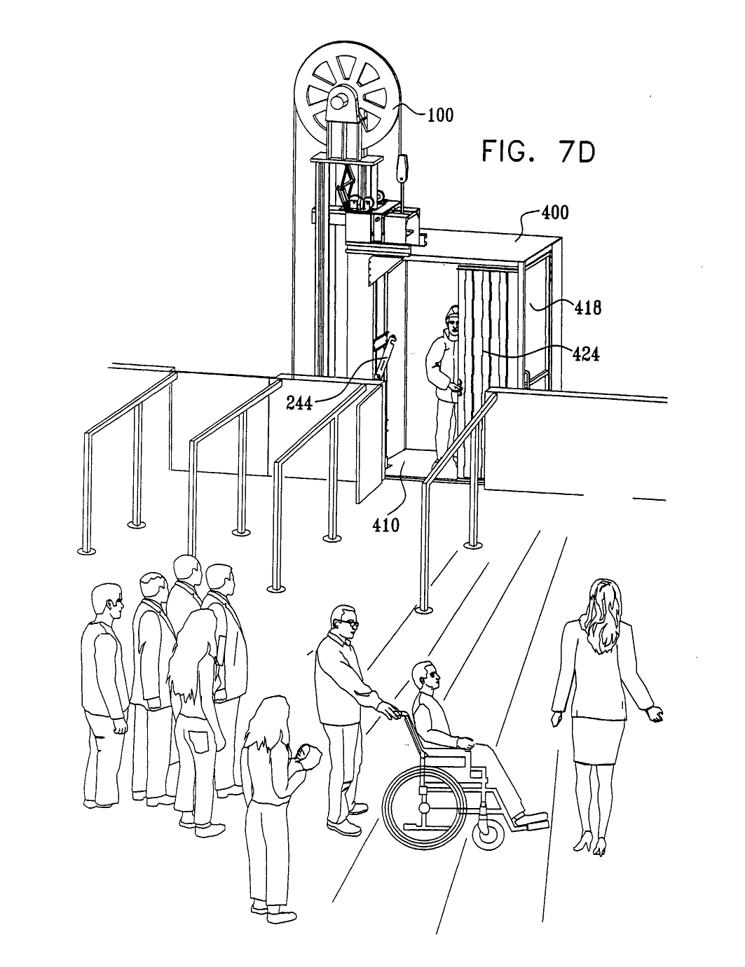

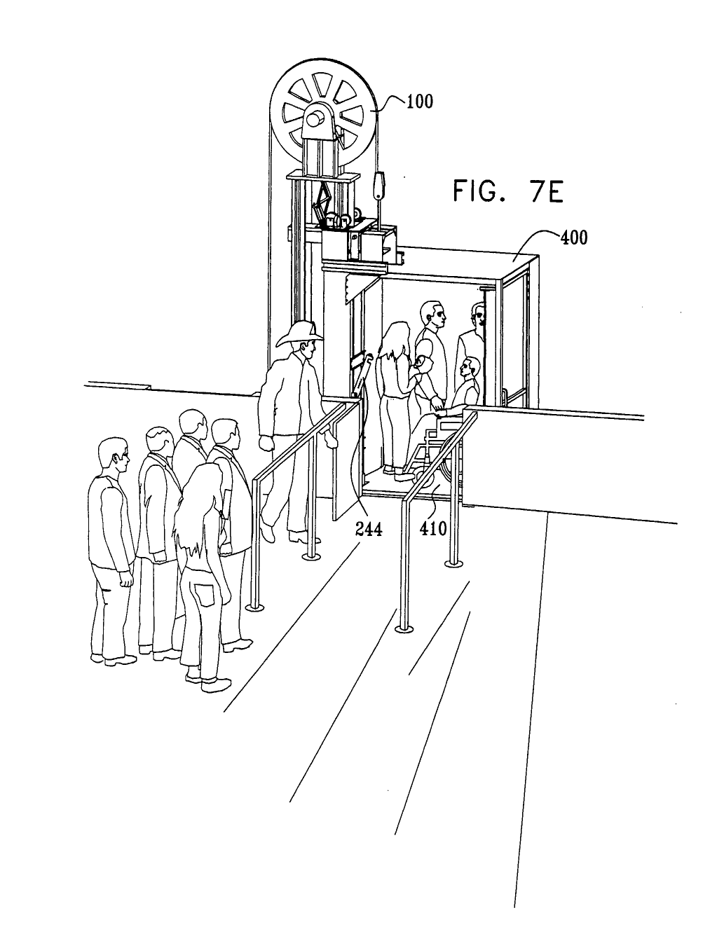

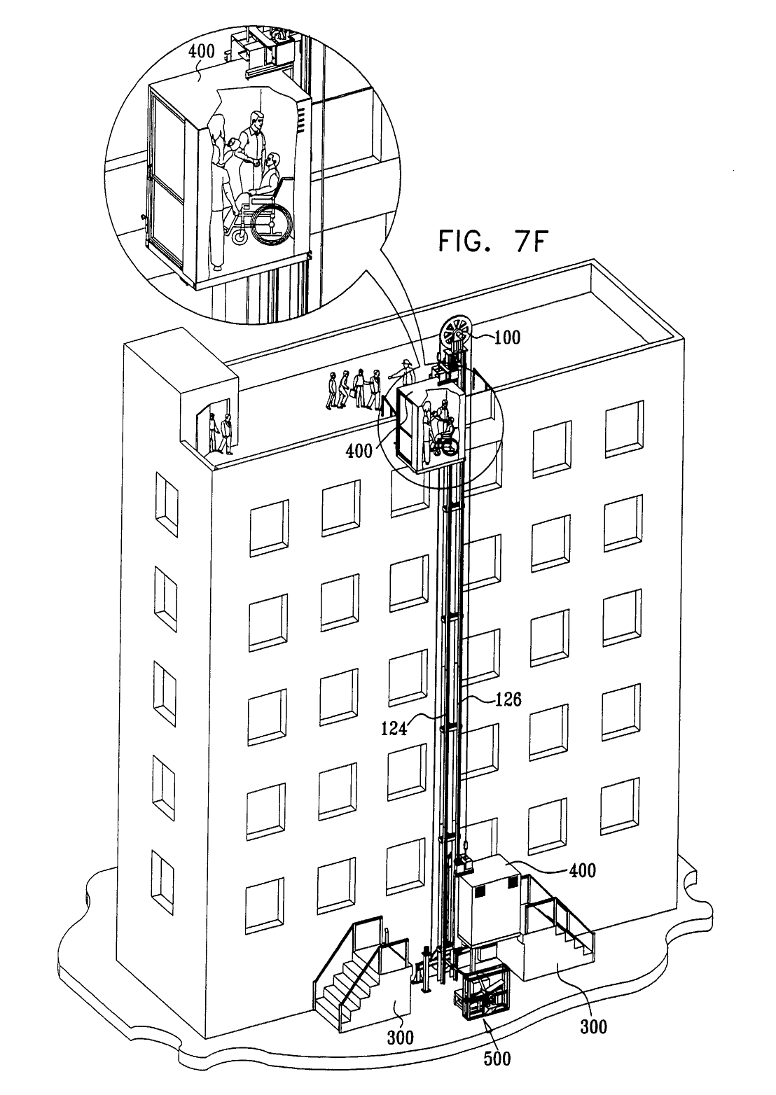

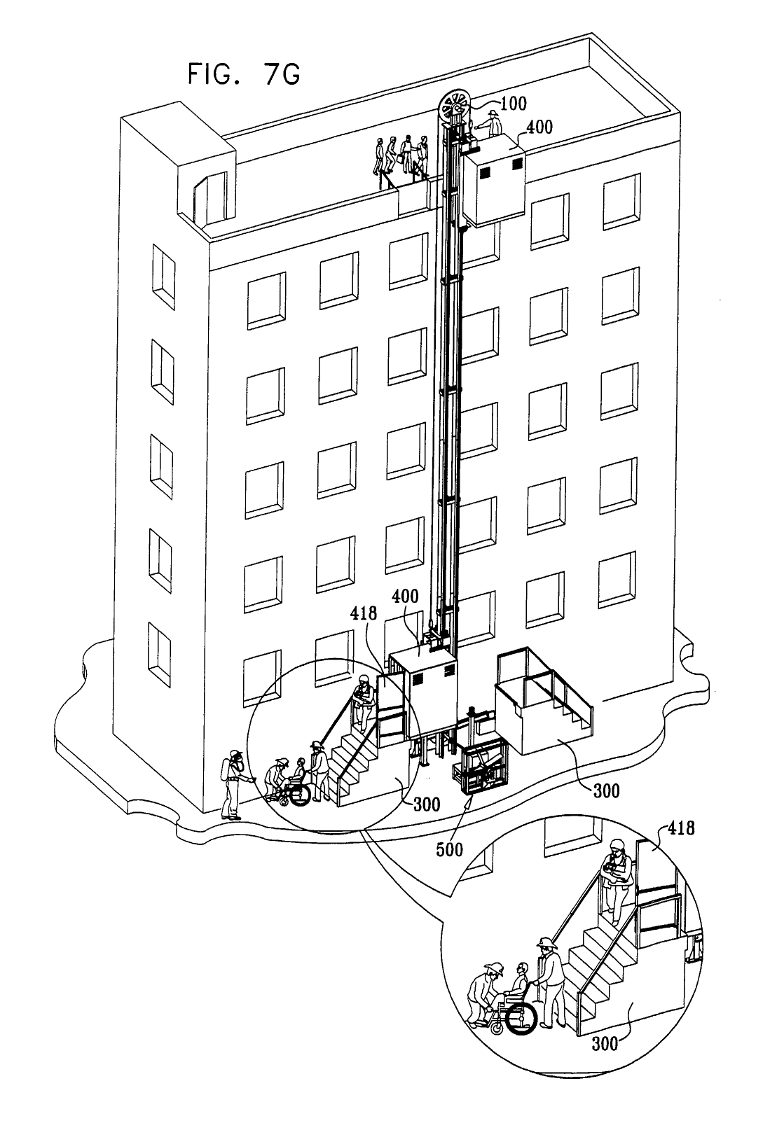

Reference is now made to FIGS. 7A-7G, which are simplified pictorial illustrations of typical use of the mass rescue and evacuation system of FIGS. 1-6. Turning to FIG. 7A, it is seen that a rescue person is entering cabin 400 via stairs 300 and that another rescue person is pulling downward on handle 532 to release brake assembly 530 and thereby permit operation of the mass rescue and evacuation system. Once brake assembly 530 is thus released, no further engagement with handle 532 is required throughout operation of the system, other than if it is wished to stop a cabin at a location intermediate its top and bottom locations. It is appreciated that the system of FIGS. 1-6 can be employed to raise rescue personnel to any level of a building or other structure.

Reference is now made to FIG. 7B, which illustrates cabin 400 being raised by the weight of counterweight 140. Vertical motion of the cabin begins only after door 418 is closed. It is appreciated that the weight of counterweight 140 is preferably greater than that of cabin 400 loaded with one or two rescue personnel and their equipment, so as to be able to provide raising of cabin 400 under gravitational acceleration and without requiring an external source of energy. FIG. 7C shows cabin 400 approaching the roof of the building, its rate of ascent being slowed by the fan descender assembly 500.

FIG. 7D shows the cabin 400 at the roof of the building, the sliding entrance door 424 being opened by a rescue person and occupants of the building being ready for evacuation. It is noted that safety device 244 is in an activated state, thus preventing vertical motion of the cabin 400 so long as the door 424 is open. FIG. 7E shows loading of the cabin 400 by evacuees. Typically, the cabin 400 accommodates at least 10 persons and may accommodate wheelchair bound persons.

FIG. 7F shows that during loading of cabin 400, while entrance door 424 is open, preferably the counterweight 140 is replaced by a second cabin 400. Since the loaded cabin 400 weighs more than the empty or partially empty second cabin, once entrance door 424 is closed, the first cabin descends while the second cabin is raised correspondingly, and the system reaches the orientation shown in FIG. 7G, at which the evacuees leave cabin 400 via exit door 418 and stairs 300 as shown.

It is appreciated that the cabins 400 can be stopped at intermediate levels of the building by suitable operation of brake handle 532 by an authorized operator.

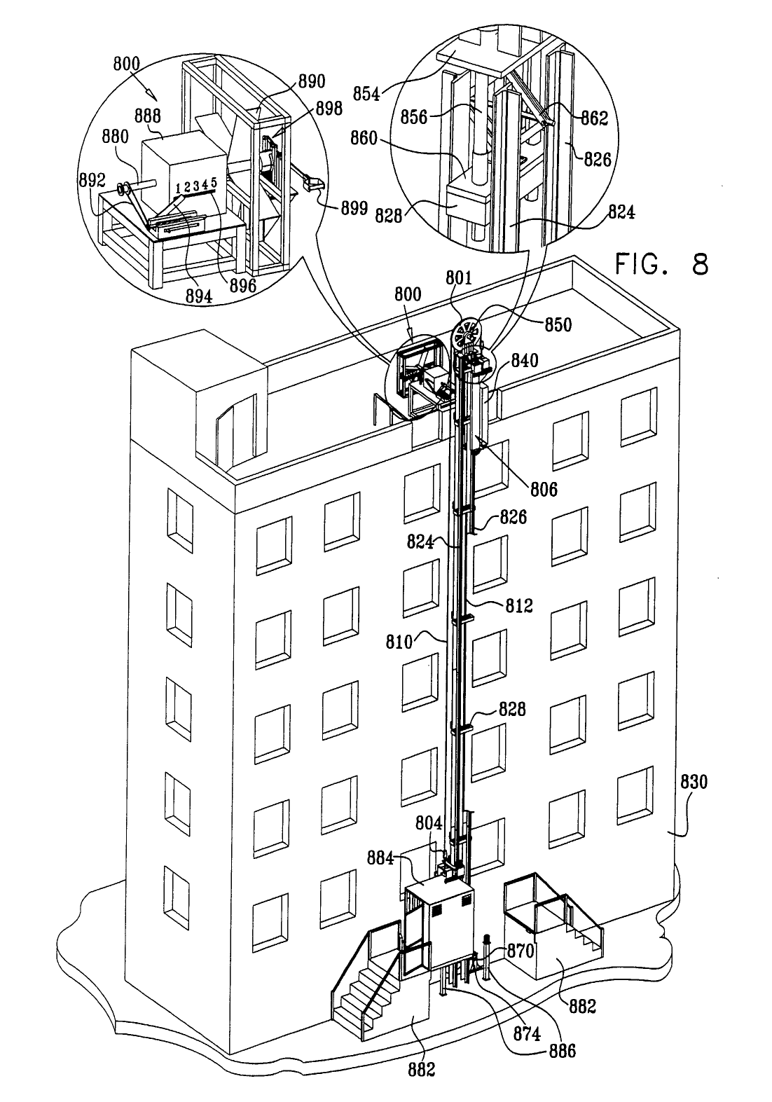

Reference is now made to FIG. 8, which is a simplified illustration of an alternative embodiment of the mass rescue and evacuation system of the present invention. The embodiment of FIG. 8 is similar to that of FIGS. 1-7G, other than in that the a fan descender assembly 800 is located at the top of the mass rescue and evacuation system rather than at the bottom as in the embodiment of FIGS. 1-7G. This is particularly suitable for enabling actuation of the system by an authorized person located within the building.

In the embodiment of FIG. 8, the mass rescue and evacuation system is a passive, gravity-operated system and preferably includes a top sheave 801 and a bottom sheave (not shown). Preferably top sheave 801 is a traction sheave, while the bottom sheave is a tension sheave. A pair of cabin mount assemblies, designated by reference numerals 804 and 806 are arranged for gravity-driven, generally vertical motion between top sheave 801 and the bottom sheave and are mounted on first and second cables 810 and 812, which are wound over the top sheave 801 and the bottom sheave.

Cable 810, known as a suspension cable, extends from the top of cabin mount assembly 804, over traction sheave 801 to the top of cabin mount assembly 806 and thus supports both cabin mount assemblies 804 and 806. Cable 812, known as a compensation cable, extends from the bottom of cabin mount assembly 804 under the deflection sheave to the bottom of cabin mount assembly 806.

The cabin mount assemblies 804 and 806 each ride along a pair of generally vertical guiding rails, respectively designated by reference numerals 824 and 826, which are mounted on vertically spaced brackets 828, which are, in turn, fixed to a wall 830 of a building in spaced relationship therewith, by respective wall mounts (not shown). Typically, when the mass rescue and evacuation system is not in use, cabins are not attached to cabin mount assemblies 804 and 806, but a counterweight 840 is mounted on one of the cabin mount assemblies, here cabin mount assembly 806, which is located at the top of the building, in order to provide initial, gravity-driven vertical motion of the system. It is appreciated that evacuation need not necessarily take place from the top of the building but rather may take place from any desired level or levels.

Traction sheave 801 is rotatably mounted on a generally horizontal axle 850 which is fixed onto an axle mount (not shown). The axle mount, is in turn mounted on a support element 854, which in turn is mounted on a pair of guide rods 856, which slidably extend through guide sockets (not shown), which are fixedly mounted onto the uppermost rail mounting bracket 828, here designated by reference numeral 860. Support element 854 is in turn supported onto a manually vertically adjustable lifting jack 862, which is mounted onto bracket 860 and provides selectably adjustable vertical positioning of traction sheave 801. Vertical adjustment of the mounting height of axle 850 takes place from time to time in order to compensate for natural cable elongation which takes place over time.

The deflection sheave is mounted onto a lever arm 870, which is pivotably mounted at one end thereof onto an anchored post 874. An opposite end of lever arm 870 is weighted by a static weight (not shown), thus tensioning cables 810 and 812, to an extent required for suitable traction between cable 810 and traction sheave 801. A connection shaft 880 extends perpendicularly from a center of traction sheave 801 and is arranged for connection to fan descender assembly 800.

Stair units 882 may be provided when the system is in its non-deployed operative orientation or may be moved into place when an emergency situation occurs. Alternatively stair units 882 may be obviated, as in the embodiment shown in FIG. 3B.

Normally, cabins are not mounted onto the remainder of the system when the system is in its non-deployed operative orientation. Alternatively, one or both cabins may be mounted onto the system at all times. FIG. 8 shows a cabin 884 mounted onto cabin mount assembly 804. Cabin 884 may be similar in all relevant aspects to cabin 400 described hereinabove with reference to FIGS. 5A and 5B. A pair of buffers 886 are also illustrated, one of which underlies and is engaged by cabin 884.

As explained above with reference to the embodiment of FIGS. 1-7G, fan descender assembly 800 is operative to slow the descent of a loaded cabin 884 in response to gravitational acceleration to no more than a predetermined speed, preferably 3.5 meters per second.

The fan descender assembly 800 includes a reducing gearbox 888, typically having selectable gear ratios of 1:8 and 1:28. An output shaft of gearbox 888 is coupled to a fan 890, preferably providing sufficient dynamic resistance to limit the speed of descent of the cabin 884 under gravitational acceleration to 3.5 meters per second.

Rotation of the connection shaft 880 is also coupled, preferably by a chain 892, to an automatic vertical position dependent gear ratio controller 894, which is operative, on the basis of the sensed rotation of the shaft 880 to determine the vertical position of the cabin 884 and to set the gear ratio accordingly. Thus, typically, when the loaded cabin 884 is lowered to a height of 10 meters above its intended landing position, the increased gear ratio is applied, thus reducing the speed of descent to a leveling speed of 1 meter per second. Preferably, associated with the gear ratio controller 894 is a mechanical visually sensible vertical position indicator 896. The descending cabin 400 comes to a complete stop by engagement with buffer 886. The height of the buffer 886 determines the exact level at which the cabins are stopped.

The output shaft of gearbox 888 is also preferably coupled to a mechanical brake assembly 898 which is normally locked, preventing vertical motion of the system. An authorized operator may operate a handle 899 of brake assembly 898, typically moving it downward, to unlock the brake assembly 898 and thus enable operation of the system. The visually sensible vertical position indicator 896 may be employed by the authorized operator to move the brake handle 899 upward thereby to stop the cabin 884 at an intermediate level of the building, if desired.

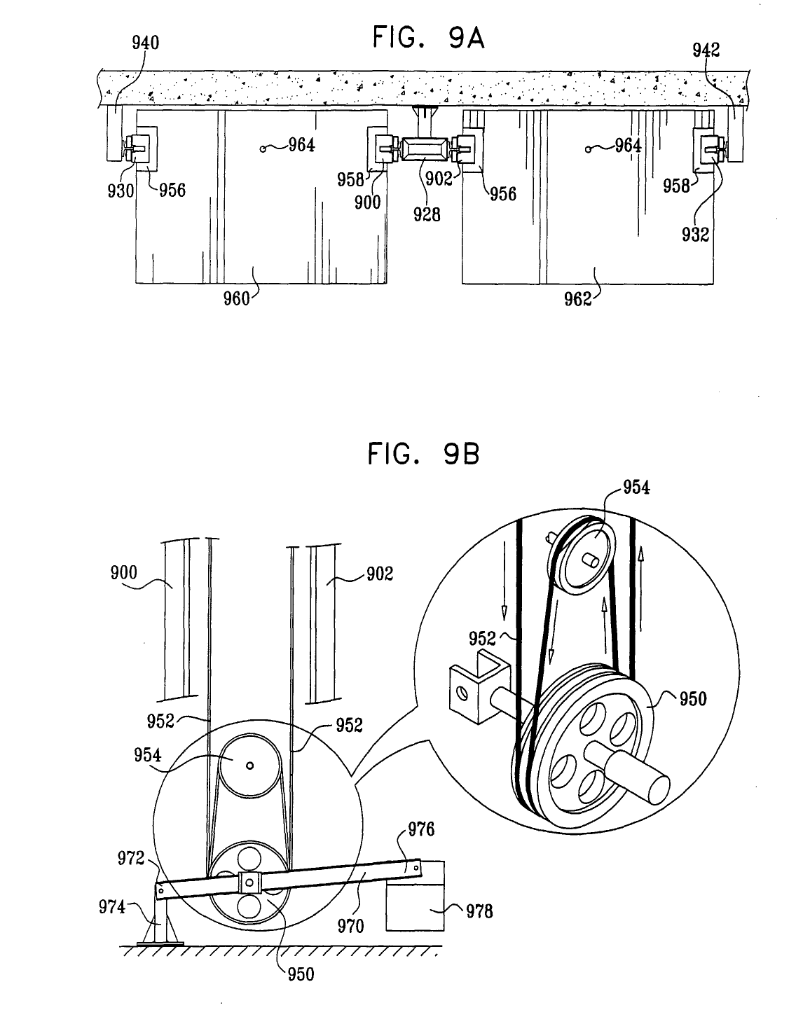

Reference is now made to FIGS. 9A and 9B, which illustrate two features of an alternative embodiment of the mass rescue and evacuation system of the present invention. The embodiment of FIGS. 9A and 9B is similar to the embodiment of FIGS. 1-7G other than in the arrangement of the guiding rails. Whereas in the embodiment of FIGS. 1-7G, all four of the guiding rails 124 and 126 (FIGS. 1-2B) are mounted on brackets 128, in the embodiment of FIGS. 9A and 9B, rails 900 and 902 are mounted on the same brackets 928, while rails 930 and 932 are mounted, each on respective separate brackets 940 and 942 and are spaced from corresponding rails 930 and 932 by a distance slightly larger than the width of a cabin, such that each cabin is guided on each of its sides by a rail. This embodiment is particularly suitable for use with relatively large cabins, such as those which can accommodate up to approximately 100 people.

It is appreciated that the embodiment of FIG. 9A preferably employs a double-wrap cable winding arrangement about the traction sheave 950, as shown in FIG. 9B, thereby to increase the traction between a cable 952 and the traction sheave 950. This enables relatively large loads to be accommodated at relatively high vertical speeds.

As seen in FIG. 9B, the double-wrap cable winding arrangement provides winding of cable 952 initially about traction sheave 950, then about a deflection sheave 954 and then again about traction sheave 950.

In the embodiment of FIGS. 9A and 9B, the mass rescue and evacuation system is a passive, gravity-operated system and preferably includes a top sheave (not shown) which is a deflection sheave and bottom sheaves 950 and 954. A pair of cabin mount assemblies, designated by reference numerals 956 and 958 is arranged for supporting each of two cabins, respectively designated by reference numerals 960 and 962.

Cabins 960 and 962 are arranged for gravity-driven, generally vertical motion and are mounted on a first cable 964 and a second cable 952, which is wound in a double-wrap arrangement over sheaves 950 and 954, as described hereinabove. First cable 964, known as a suspension cable, extends from the top of cabin 960, over the top sheave to the top of cabin 962 and thus supports both cabins 960 and 962. Cable 952, known as a traction cable, extends from the bottom of cabin 960 in a double-wrap arrangement about sheaves 950 and 954 to the bottom of cabin 962.

The cabin mount assemblies 956 and 958 of cabin 960 ride along respective guiding rails 900 and 930, while cabin mount assemblies 956 and 958 of cabin 962 ride along respective guiding rails 902 and 932. Typically, when the mass rescue and evacuation system is not in use, cabins 960 and 962 are not attached to the remainder of the mass rescue and evacuation system, but a counterweight (not shown) is mounted on one of the cabin mount assemblies, which is located at the top of the building, in order to provide initial, gravity-driven vertical motion of the system. It is appreciated that evacuation need not necessarily take place from the top of the building but rather may take place from any desired level or levels.

Traction sheave 950 is mounted onto a lever arm 970, which is pivotably mounted at one end thereof, designated by reference numeral 972 onto an anchored post 974. An opposite end 976 of lever arm 970 is weighted by a static weight 978, thus tensioning cables 952 and 964, to an extent required for suitable traction between cable 952 and traction sheave 950. A connection shaft (not shown) extends perpendicularly from a center of traction sheave 950 and is arranged for connection to a fan descender assembly (not shown).

Stair units (not shown) may be provided when the system is in its non-deployed operative orientation or may be moved into place when an emergency situation occurs. Alternatively the stair units may be obviated, as in the embodiment shown in FIG. 3B.

Normally, cabins are not mounted onto the remainder of the system when the system is in its non-deployed operative orientation. Alternatively, one or both cabins may be mounted onto the system at all times. FIG. 9A shows cabins 960 and 962 mounted onto cabin mount assemblies 956 and 958. Cabins 960 and 962 may be similar in all relevant aspects to cabin 400 described hereinabove with reference to FIGS. 5A and 5B.

As explained above with reference to the embodiment of FIGS. 1-7G, the fan descender assembly (not shown) is operative to slow the descent of a loaded cabin in response to gravitational acceleration to no more than a predetermined speed, preferably 3.5 meters per second. The fan descender assembly may be similar to the fan descender assemblies described hereinabove.

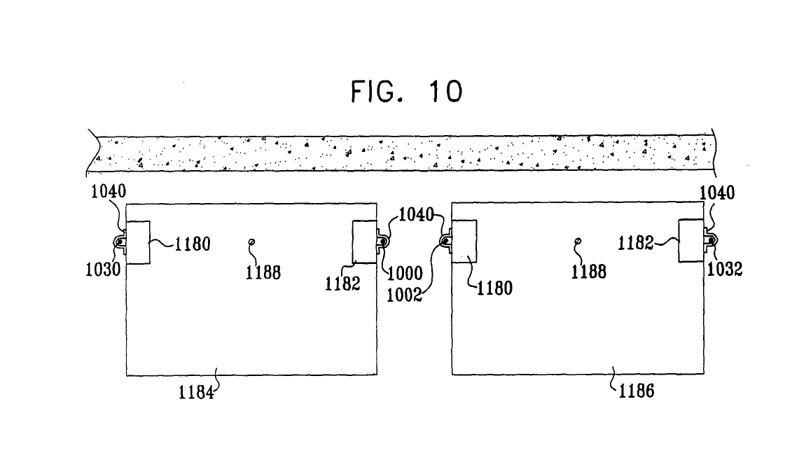

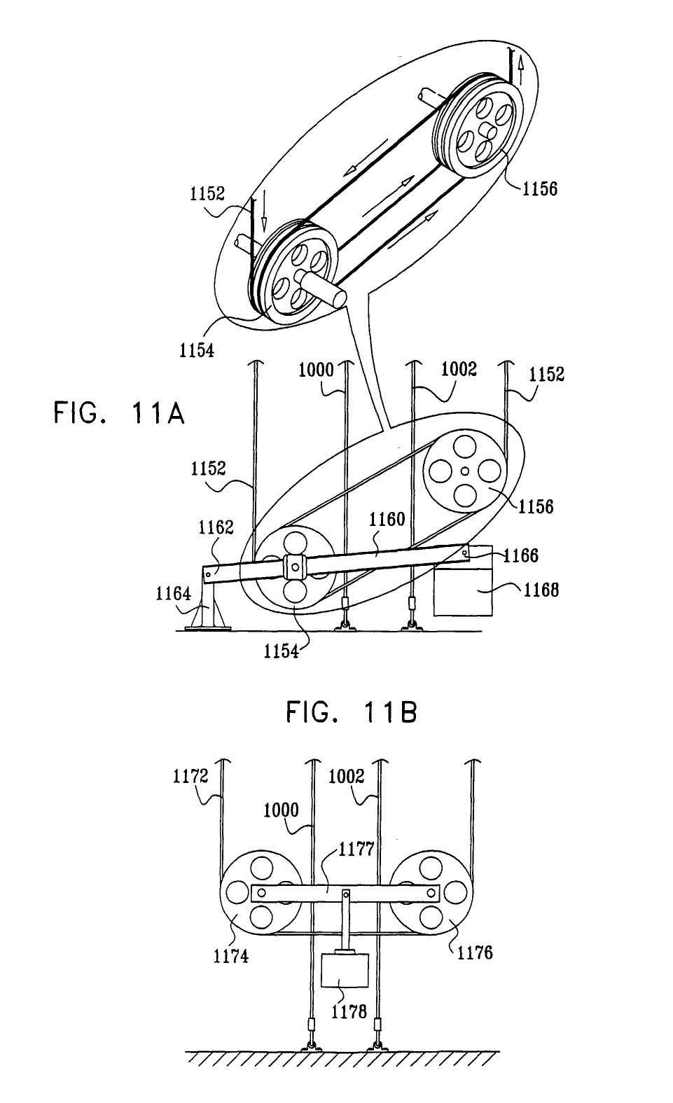

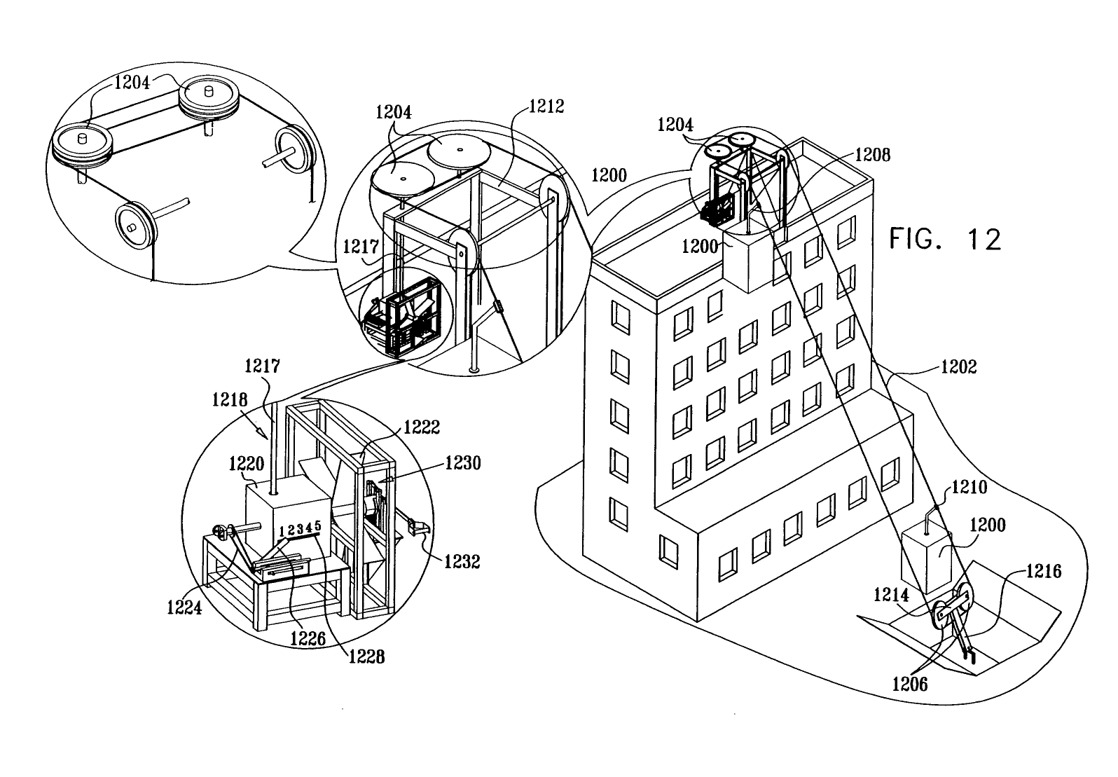

Reference is now made to FIGS. 10, 11A and 11B, which illustrate a further alternative embodiment of the present invention. As seen in FIG. 10A, the embodiment of FIGS. 10-11B is similar to that shown in FIG. 9A other than in that the guide rails 900, 902, 930 and 932 are replaced by tensioned guide wires 1000, 1002, 1030 and 1032. The guide wires are engaged by slidable guiding shoes 1040 mounted on cabin mount assemblies arranged at the sides of the cabins.

Due to the replacement of rails by tensioned cables, a balancing type of cable tensioning arrangement is preferably provided. FIG. 11A shows a suitable double-wrap cable winding arrangement for a system wherein a fan descender assembly is located at the bottom of the mass rescue and evacuation system. As seen in FIG. 11A, a traction cable 1152 is wound first about a traction sheave 1154, then wound about a deflection sheave 1156 and again wound about traction sheave 1154 and again wound about deflection sheave 1156.

Deflection sheave 1156 is rotatably mounted at a fixed location. Traction sheave 1154 is mounted onto lever arm 1160 which is pivotably mounted at one end thereof, designated by reference numeral 1162 onto an anchored post 1164. An opposite end 1166 of lever arm 1160 is weighted by a static weight 1168, thus tensioning cable 1152 to an extent required for suitable traction between cable 1152 and sheaves 1154 and 1156.

FIG. 11B shows a suitable cable winding arrangement for a system wherein the fan descender assembly is located at the top of the mass rescue and evacuation system. As seen in FIG. 11B, a tension cable 1172 is wound first about a first deflection sheave 1174 and then wound about a second deflection sheave 1176.

Deflection sheaves 1174 and 1176 are each rotatably mounted in mutually spaced positions onto a mounting beam 1177, which is weighted by a static weight 1178, thus tensioning cable 1172 to an extent required for suitable traction between cable 1172 and sheaves 1174 and 1176.

In the embodiments of FIGS. 10-11B, the mass rescue and evacuation system is a passive, gravity-operated system and preferably includes top sheaves (not shown) and bottom sheaves 1154 & 1156 or 1174 & 1176. A pair of cabin mount assemblies, designated by reference numerals 1180 and 1182, is arranged for supporting each of two cabins, respectively designated by reference numerals 1184 and 1186.

Cabins 1184 and 1186 are arranged for gravity-driven, generally vertical motion and are mounted on a traction cable and a tension cable.

In the embodiment of FIG. 11A, where the fan descender assembly is located at the bottom, the traction cable is at the bottom and indicated as traction cable 1152 which is wound in a double-wrap arrangement over sheaves 1154 and 1156, as described hereinabove.

In the embodiment of FIG. 11B, where the fan descender assembly is located at the top, the traction cable is at the top and tension cable 1172 is at the bottom and is wound over sheaves 1174 and 1176, as described hereinabove.

In both embodiments, a top cable 1188 extends from the top of cabin 1184, over the top sheave to the top of cabin 1186 and thus supports both cabins 1184 and 1186.

The cabin mount assemblies 1180 and 1182 of cabin 1184 ride along respective tensioned guide wires 1000 and 1030, while cabin mount assemblies 1180 and 1182 of cabin 1186 ride along respective tensioned guiding wires 1002 and 1032. Typically, when the mass rescue and evacuation system is not in use, cabins 1184 and 1186 are not attached to the remainder of the mass rescue and evacuation system, but a counterweight (not shown) is mounted on one of the cabin mount assemblies, which is located at the top of the building, in order to provide initial, gravity-driven vertical motion of the system. It is appreciated that evacuation need not necessarily take place from the top of the building but rather may take place from any desired level or levels.

Stair units (not shown) may be provided when the system is in its non-deployed operative orientation or may be moved into place when an emergency situation occurs. Alternatively the stair units may be obviated, as in the embodiment shown in FIG. 3B.

As explained above with reference to the embodiment of FIGS. 1-7G, the fan descender assembly (not shown) is operative to slow the descent of a loaded cabin in response to gravitational acceleration to no more than a predetermined speed, preferably 3.5 meters per second. The fan descender assembly may be similar to the fan descender assemblies described hereinabove.

Reference is now made to FIG. 12, which is a simplified pictorial illustration of yet another alternative embodiment of the present invention. In the embodiment of FIG. 12, which has various similarities to features in the embodiments of FIGS. 1-11, an inclined cabin travel path is provided, so as to quickly distance a descending cabin from the building. In the embodiment of FIG. 12, cabins 1200 are suspending from a tensioned looped cable 1202 as shown.

In the embodiment of FIG. 12, the mass rescue and evacuation system is a passive, gravity-operated system and preferably includes top and bottom pairs of sheaves 1204 and 1206. Preferably top sheaves 1204 are traction sheaves, while bottom sheaves 1206 are tension sheaves. A pair of cabin suspension assemblies, designated by reference numerals 1208 and 1210 are arranged for gravity-driven, inclined vertical motion between pairs of sheaves 1204 and 1206 and are mounted on tensioned looped cable 1202, which is wound over pairs of sheaves 1204 and 1206. Cabin suspension assemblies 1208 and 1210 may be of the type used conventionally in cable cars.

Typically, when the mass rescue and evacuation system is not in use, cabins are not attached to cabin mount assemblies 1208 and 1210, but a counterweight (not shown) is mounted on one of the cabin mount assemblies, which is located at the top of the building, in order to provide initial, gravity-driven vertical motion of the system. It is appreciated that evacuation need not necessarily take place from the top of the building but rather may take place from any desired level or levels.

Traction sheaves 1204 are rotatably mounted in fixed mutually spaced positions on a frame 1212 and looped cable 1202 is double wrapped about traction sheaves 1204.

Deflection sheaves 1206 are rotatably mounted in fixed mutually spaced position onto a beam 1214, which is in turn mounted in a selectably tensionable manner to an anchor 1216, thus tensioning looped cable 1202 to an extent required for suitable traction between cable 1202 and traction sheaves 1204. A connection shaft 1217 extends perpendicularly from a center of a traction sheave 1204 and is arranged for connection to a fan descender assembly 1218.

As explained above with reference to the embodiment of FIGS. 1-7G, fan descender assembly 1218 is operative to slow the descent of a loaded cabin 1200 in response to gravitational acceleration to no more than a predetermined speed, preferably 3.5 meters per second.

The fan descender assembly 1218 includes a reducing gearbox 1220, typically having selectable gear ratios of 1:8 and 1:28. An output shaft of gearbox 1220 is coupled to a fan 1222, preferably providing sufficient dynamic resistance to limit the speed of descent of the cabin 1200 under gravitational acceleration to 3.5 meters per second.

Rotation of the connection shaft 1217 is also coupled, preferably by a chain 1224, to an automatic vertical position dependent gear ratio controller 1226, which is operative, on the basis of the sensed rotation of the shaft 1217 to determine the vertical position of the cabin 1200 and to set the gear ratio accordingly. Thus, typically, when the loaded cabin 1200 is lowered to a height of 10 meters above its intended landing position, the increased gear ratio is applied, thus reducing the speed of descent to a leveling speed of 1 meter per second. Preferably, associated with the gear ratio controller 1226 is a mechanical visually sensible vertical position indicator 1228.

The output shaft of gearbox 1220 is also preferably coupled to a mechanical brake assembly 1230 which is normally locked, preventing vertical motion of the system. An authorized operator may operate a handle 1232 of brake assembly 1230, typically moving it downward, to unlock the brake assembly 1230 and thus enable operation of the system.

It is appreciated that in the various embodiments of the present invention, multiple suspension and compensation cables may be provided in place of single cables, as appropriate.

It is also appreciated that multiple mass rescue and evacuation systems may be mounted on a given building and may be of differing configurations depending on the physical features of the building and other requirements. The provision of multiple mass rescue and evacuation systems enables evacuation from alternative exit locations in the building.

It is appreciated that although many of the embodiments described hereinabove are at least partially assembled at the time of deployment, alternatively, the mass rescue and evacuation system may be fully assembled and ready to use at all times. In such a case, a counterweight is preferably incorporated in the upper cabin and preferably is arranged to be removable when that cabin reaches its lower position.

It will be appreciated by persons skilled in the art that the present invention is not limited to what has been particularly shown and described hereinabove. Rather the present invention includes both combinations and subcombinations of the features described hereinabove as well as modifications and variations which would occur to persons skilled in the art upon reading the foregoing description and which are not in the prior art.

1. A mass rescue system comprising:
at least one upper rotatable support;
at least one lower rotatable support disposed below said at least one upper rotatable support;
at least one elongate flexible element wound about said at least one upper and at least one lower rotatable supports; and
at least first and second rescue platforms mounted on said at least one elongate flexible element at locations therealong arranged with respect to said upper and lower rotatable supports such that downward motion of said first rescue platform produces concomitant upward motion of said second rescue platform and vice versa,
said first and second rescue platforms, when loaded to different weights, being operative to undergo upward and downward motion produced by gravitational acceleration and without requiring an external energy source.

2. A mass rescue system according to claim 1 and also comprising a dynamic resistance device operative to employ potential energy of said at least first and second rescue platforms for braking downward motion thereof.

3. A mass rescue system according to claim 1 and wherein said at least one elongate flexible element comprises at least one first elongate flexible element which is wound over said upper rotatable support and at least one second elongate flexible element which is wound under said lower rotatable support.

4. A mass rescue system according to claim 1 and wherein said at least one elongate flexible element comprises a looped elongate element.

5. A mass rescue system according to claim 1 and also comprising at least one guiding element which is operative to guide said first and second rescue platforms.

6. A mass rescue system according to claim 5 and wherein said at least one guiding element comprises at least one rigid element.

7. A mass rescue system according to claim 5 and wherein said at least one guiding element comprises at least one elongate flexible element.

8. A mass rescue system according to claim 1 and also comprising a counterweight operative to provide initial downward motion under gravitational acceleration and without requiring an external energy source.

9. A mass rescue system according to claim 1 and wherein at least one of said first and second rescue platforms comprises a cabin.

10. A mass rescue system according to claim 4 and wherein at least one of said first and second rescue platforms includes at least one guide assembly which rides along said at least one guiding element and which is operative to reduce transverse displacement of said rescue platform.

11. A mass rescue system according to claim 1 and wherein at least one of said first and second rescue platforms also comprises a safety assembly operative to prevent free-fall of said rescue platform.

12. A mass rescue system according to claim 1 and also comprising at least one stair unit associated with said first and second rescue platforms.

13. A mass rescue system according to claim 1 and wherein at least one of said first and second rescue platforms also comprises at least one door and at least one door safety element operative to prevent vertical motion of said rescue platform while said at least one door is open.

14. A mass rescue system according to claim 1 and wherein at least one of said first and second rescue platforms also comprises at least one of a first aid kit and a communications device.

15. A mass rescue system according to claim 2 and wherein said dynamic resistance device is operative to slow vertical motion of at least one of said first and second rescue platforms to a speed which is less than a predetermined speed.

16. A mass rescue system according to claim 2 and wherein said dynamic resistance device also comprises a reducing gearbox and a fan descender which are operative to slow the vertical motion of said first and second rescue platforms.

17. A mass rescue system according to claim 16 and wherein said dynamic resistance device also comprises a position dependent gear controller operative to control the gear ratio of said reducing gearbox as a function of a vertical position of at least one of said first and second rescue platforms.

18. A mass rescue system according to claim 17 and wherein said dynamic resistance device also comprises a visually sensible position indicator associated with said position dependent gear controller.

19. A mass rescue system according to claim 2 and wherein said dynamic resistance device also comprises a mechanical brake assembly operative, when in a first position, to prevent vertical motion of said first and second rescue platforms.

20. A mass rescue system according to claim 19 and wherein said mechanical brake assembly also comprises a handle which is selectably movable between said first position and a second position to enable a user to selectably operate said system.

21. A mass rescue system according to claim 1 and also comprising at least one buffer for final stopping of vertical motion of said first and second rescue platforms.

22. A method for mass rescue comprising:
providing upper and lower rotatable supports having at least one elongate flexible element wound thereabout, said at least one elongate flexible element having at least first and second rescue platforms mounted at locations therealong arranged with respect to said upper and lower rotatable supports such that downward motion of said first rescue platform produces concomitant upward motion of said second rescue platform and vice versa;
providing dynamic resistance governing vertical motion of said at least one elongate flexible element with respect to said upper and lower rotatable supports; and
loading said first and second rescue platforms to different weights such that said first and second rescue platforms undergo upward and downward motion produced by gravitational acceleration and without requiring an external energy source.

23. A method according to claim 20 and also comprising:
providing at least one guiding element which is operative to guide said first and second rescue platforms; and
mounting said at least one guiding element onto a building.

24. A method according to claim 22 and also comprising operating a brake assembly to enable vertical motion of at least one of said first and second rescue platforms.

25. A method according to claim 24 and also comprising operating said brake assembly to stop at least one of said first and second rescue platforms at a selectable level.

26. A method according to claim 22 and also comprising:
prior to said providing a second rescue platform, providing at least one counter weight; and
loading said first platform to a lower weight than a weight of said counterweight such that downward gravitational motion of said counterweight results in upward motion of said first platform.

27. A mass rescue system comprising:
an upper rotatable support;
a lower rotatable support disposed below said upper rotatable support;
at least one elongate flexible element wound about said upper and lower rotatable supports; and
a first rescue platform and a counterweight mounted on said at least one elongate flexible element at locations therealong arranged with respect to said upper and lower rotatable supports such that downward motion of said first rescue platform produces concomitant upward motion of said counterweight and vice versa,
said first rescue platform having a weight, when loaded to at least a first predetermined extent, which is greater than a weight of said counterweight and thus being operative to undergo downward motion produced by gravitational acceleration, causing concomitant upward motion of said counterweight, and
said first rescue platform having a weight, when unloaded to at least a second predetermined extent, which is less than the weight of said counterweight and thus said counterweight is operative to undergo downward motion produced by gravitational acceleration, causing concomitant upward motion of said first rescue platform, when unloaded to at least a second predetermined extent.

28. A mass rescue system according to claim 27 and wherein said counterweight comprises at least a second rescue platform having a weight, when unloaded to at least a second predetermined extent, which is less than the weight of said first rescue platform, when loaded to at least a third predetermined extent and thus said counterweight is operative to undergo downward motion produced by gravitational acceleration, causing concomitant upward motion of said first rescue platform, when unloaded to at least a second predetermined extent.

29. A mass rescue system according to claim 27 and also comprising a dynamic resistance device operative to employ potential energy of said first rescue platform for braking downward motion thereof.

30. A mass rescue system according to claim 27 and wherein said at least one elongate flexible element comprises at least one first elongate flexible element which is wound over said upper rotatable support and at least one second elongate flexible element which is wound under said lower rotatable support.

31. A mass rescue system according to claim 27 and wherein said at least one elongate flexible element comprises a looped elongate element.

32. A mass rescue system according to claim 27 and also comprising at least one guiding element, which is operative to guide said first rescue platform and said counterweight.

33. A mass rescue system according to claim 32 and wherein said at least one guiding element comprises at least one rigid element.

34. A mass rescue system according to claim 32 and wherein said at least one guiding element comprises at least one elongate flexible element.

35. A mass rescue system according to claim 27 and wherein said first rescue platform comprises a cabin.

36. A mass rescue system according to claim 32 and wherein said first rescue platform includes at least one guide assembly which rides along said at least one guiding element and which is operative to reduce transverse displacement of said first rescue platform.

37. A mass rescue system according to claim 27 and wherein said first rescue platform also comprises a safety assembly operative to prevent free-fall of said first rescue platform.

38. A mass rescue system according to claim 27 and also comprising at least one stair unit associated with said first rescue platform.

39. A mass rescue system according to claim 27 and wherein said first rescue platform also comprises at least one door and at least one door safety element operative to prevent vertical motion of said first rescue platform while said at least one door is open.

40. A mass rescue system according to claim 27 and wherein said first rescue platform also comprises at least one of a first aid kit and a communications device.

41. A mass rescue system according to claim 29 and wherein said dynamic resistance device is operative to slow vertical motion of said first rescue platform to a speed which is less than a predetermined speed.

42. A mass rescue system according to claim 29 and wherein said dynamic resistance device also comprises a reducing gearbox and a fan descender which are operative to slow the vertical motion of said first rescue platform.

43. A mass rescue system according to claim 42 and wherein said dynamic resistance device also comprises a position dependent gear controller operative to control the gear ratio of said reducing gearbox as a function of a vertical position of said first rescue platform.

44. A mass rescue system according to claim 43 and wherein said dynamic resistance device also comprises a visually sensible position indicator associated with said position dependent gear controller.

45. A mass rescue system according to claim 29 and wherein said dynamic resistance device also comprises a mechanical brake assembly operative, when in a first position, to prevent vertical motion of said first rescue platform.

46. A mass rescue system according to claim 45 and wherein said mechanical brake assembly also comprises a handle which is selectably movable between said first position and a second position to enable a user to selectably operate said system.

47. A mass rescue system according to claim 27 and also comprising at least one buffer for final stopping of vertical motion of said first rescue platform.

48. A method for mass rescue comprising:
providing upper and lower rotatable supports having at least one elongate flexible element wound thereabout, said at least one elongate flexible element having a first rescue platform and a counterweight mounted at locations therealong arranged with respect to said upper and lower rotatable supports such that downward motion of said first rescue platform produces concomitant upward motion of said counterweight and vice versa;
providing dynamic resistance governing vertical motion of said at least one elongate flexible element with respect to said upper and lower rotatable supports; and
loading said first rescue platform to a first predetermined extent, such that it has a first weight which is greater than a weight of said counterweight, such that said first rescue platform undergoes downward motion produced by gravitational acceleration, causing concomitant upward motion of said counterweight; and
unloading said first rescue platform to at least a second predetermined extent, such that it has a second weight which is less than the weight of said counterweight and thus said counterweight is operative to undergo downward motion produced by gravitational acceleration, causing concomitant upward motion of said first rescue platform.

49. A method according to claim 48 and wherein said counterweight comprises at least a second rescue platform having a weight, when unloaded to at least a second predetermined extent, which is less than the weight of said first rescue platform, when loaded to at least a third predetermined extent and thus said counterweight is operative to undergo downward motion produced by gravitational acceleration, causing concomitant upward motion of said first rescue platform, when unloaded to at least a second predetermined extent.

50. A method according to claim 48 and also comprising:
providing at least one guiding element which is operative to guide said first rescue platform; and
mounting said at least one guiding element onto a building.

51. A method according to claim 48 and also comprising operating a brake assembly to enable vertical motion of said first rescue platform.

52. A method according to claim 51 and also comprising operating said brake assembly to stop said first rescue platform at a selectable level.
